(19) United States
(12) Patent Application Publication
(10) Pub. No.: US 2010/0275757 A1
(43) Pub. Date: Nov. 4, 2010

(54) CLAMP

(76) Inventors: Trevor Hallet, Middlesex (GB); Michael Jaeger, London (GB)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/671,511

(22) PCT Filed: Jul. 31, 2008
(86) PCT No.: PCT/GB2008/002615

§ 371 Date: Jul. 14, 2010

(30) Foreign Application Priority Data
Aug. 1, 2007 (GB) 0714962.8
Feb. 4, 2008 (GB) 0802017.4
Feb. 6, 2008 (GB) 0802222.0

(51) Int. Cl. G10D 3/04; F16B 2/02; F25D 15/00

(52) U.S. Cl. 84/318; 24/484; 62/293

(57) ABSTRACT

A clamp (1d) comprises a clamp bracket (3f) and an elastic cord (5) threaded through a pair of apertures (7b, 9b) in the clamp bracket (3f). The clamp bracket (3f) further comprises a pair of keyhole-shaped holes (19f) for receiving an end portion (31) of the cord (5). The shape of the keyhole-shaped holes (19f) is such that the cord (5) is insertable into part of the hole (19f) when the cord is tensioned and the cord (5) is gripped by inner walls of an adjoining part of the hole (19f) when the cord is untensioned.

### FIELD OF THE INVENTION

This invention relates to a clamp and in particular relates to a clamp for attaching a freeze head to a pipe.

### BACKGROUND OF THE INVENTION

Pipe freezing is used to freeze the contents of liquid-filled pipes when maintenance or repair is to be undertaken on the pipe. Freezing the contents of the pipe eliminates the need to drain the system, of which the pipe forms a component part, and hence speeds up the repair of the system. Pipe freezing is particularly useful for domestic and light industrial water based heating systems, using pipe diameters up to about 88 mm.

Pipe freezing is performed either by applying a liquefied gas, such as liquid nitrogen or carbon dioxide, to a sleeve around the pipe or by using an electric pipe freezing machine. Electric pipe freezing machines supply a cooled refrigerant to a freeze head which is held against a liquid-filled pipe to cool and freeze the contents of the pipe where the freeze head is placed. The freeze head comprises a curved recess to receive the pipe to be frozen. The freeze head preferably encompasses a large proportion of the circumference of the pipe, typically up to 180° of the circumference, to maximise thermal transfer to the pipe. Such machines are manufactured by the present applicant and by Rothenberger Werkzeuge AG and described in EP-A-0145114, EP-A-0813020 for example, the contents of which are incorporated herein by reference.

To efficiently freeze the contents of a pipe, the freeze head should be applied to and held on the pipe by a clamp in such a manner as to provide good thermal transfer between the freeze head and the pipe. It can often be difficult to hold the freeze head against the pipe due to a lack of access to the pipe. Pipes are often mounted on a wall typically with between 10 mm and 15 mm clearance between the wall and the pipe. Two pipes are often run parallel and close to each other, for example hot and cold water pipes or feed and return pipes, restricting access between the pipes. Pipes which run in a corner of a room also suffer from limited access.

The present applicant uses a G-clamp to hold the freeze head on the pipe. Commonly available G-clamps can often not be used because the head of the ‘G’ is too large to fit between the pipe and the wall. Therefore, the present applicant has developed a G-clamp made of bent metal plate, the head of the ‘G’ being thinner than the head of the ‘G’ of commonly available G-clamps. However, as the clamp is made from thinner metal than commonly available G-clamps the clamp is prone to bending as a result of an excess gripping force applied by the operator. Furthermore, this clamp still suffers from difficulties in attaching the freeze head when there is limited access to the pipe.

GB-A-2314297in the name of Rothenberger Werkzeuge AG describes a pipe freezing head having a partially cylindrical seat for receiving a pipe. The freeze head has an extension in which a clamping spindle is mounted to fasten the freeze head to the pipe, effectively providing the freeze head with an integral clamp. This head suffers from similar accessibility disadvantages to the flat plate clamp described above, in particular because the head and integral clamp surround more than 180° of the circumference of the pipe.

Both the above clamps are also prone to overtightening which may damage the pipe and/or the clamp.

Other arrangements for holding the freeze head on a pipe include using a crocodile clip or a hook-and-loop type fastener. The crocodile clip arrangement suffers from the same problems of access and potential damage to the pipe as the clamps described above while the hook-and-loop type fastener cannot be tightened adequately to hold the freeze head in place on the pipe and is prone to slipping.

### SUMMARY OF THE INVENTION

The invention provides a clamp comprising: a clamp bracket having a first aperture; and an elastic cord threaded through the first aperture; the clamp bracket further comprising: at least one hole for receiving an end portion of the cord, wherein the shape of each hole is such that the cord is insertable into part of the hole when the cord is tensioned; and the cord is gripped by inner walls of an adjoining part of the hole when the cord is untensioned.

The invention also provides a clamp comprising: a clamp bracket having a first aperture; and an elastic cord threaded through the first aperture; the clamp bracket further comprising: a pair of slots, a mouth of each slot being open to an edge of the clamp bracket for receiving an end portion of the cord, wherein the width of each slot is such that the cord is insertable into the slot when the cord is tensioned; and the cord is gripped by inner walls of the slot when the cord is untensioned.

The clamp bracket may further comprise a second aperture, wherein a central portion of the cord is threaded through the second aperture in addition to the first aperture to form a loop in the central portion of the cord between the first aperture and the second aperture.

The loop in the cord may be disposed above one face of the clamp bracket when the free ends of the cord protrude from the same face of the clamp bracket, or the loop in the cord may cross an edge of the clamp bracket, when the central portion of the cord is threaded around an edge of the clamp bracket and the free ends of the cord protrude from different faces of the clamp bracket.

One or both of the first aperture and second aperture may be substantially round or one or both of the first aperture and second aperture may be elongated.

When both of the first aperture and second aperture are elongate, the elongate aperture may be straight, the apertures may be parallel and/or a distance between first ends of the apertures may be less than a distance between second ends of the apertures.

The width of one or both apertures may be greater than the diameter of the cord when the cord is untensioned, preferably less than 20% greater than the diameter of the cord and further preferably less than 10% greater than the diameter of the cord.

The mouths of the slots may be open to the same edge of the clamp bracket of to different edges of the clamp bracket.

The mouth of a slot may taper outwards and inner edges of a root of a slot may be parallel to each other.

The clamp bracket may be flat, generally rectangular and made from aluminium plate by punching.

The clamp bracket may comprise a base plate and a flange extending from the base plate, the or both apertures and the slots being disposed in the flange. The flange may extend from an edge of the base plate such that clamp bracket is L-shaped or the flange may extend from a centre of the base plate such that clamp bracket is T-shaped.

The clamp may further comprise an opening in the flange to provide a handle to assist carrying the handle and items attached together by the handle. Alternatively a flexible band or other suitable material may be attached to the clamp plate to act as a handle.

The cord may be a bungee cord or other elastic cord. The cord may comprise a cord stop on one or both ends of the cord to prevent the cord from being withdrawn from the apertures. The cord stop may comprise a crimp.

The clamp bracket may comprise a cut-out for receiving a hose supplying refrigerant to a freeze head of a pipe freezing machine.

According to a further aspect of the invention there is provided a clamp comprising a bracket and an elastic cord, the cord reducing in diameter when stretched, the bracket having a plurality of slots extending in from one or more edge of the bracket, the slots being narrower than the diameter of the unstretched cord.

The clamp may have an aperture in which the cord is anchored to the bracket by passing the cord through an aperture.

According to a further aspect of the invention there is provided pipe freezing apparatus for freezing liquid in a liquid-filled pipe, the apparatus comprising: a freeze head to be applied to said pipe; a compressor for supplying cooled refrigerant to the freeze head; and a clamp as defined above for mounting the freeze head on said pipe.

The clamp bracket of the clamp may be attached to the freeze head, in particular the clamp bracket and the freeze head may integrally formed.

According to a further aspect of the invention there is provided a method of mounting a freeze head on a pipe, the freeze head forming part of pipe freezing apparatus as defined above, the method comprising: disposing the freeze head on the pipe; disposing the clamp against the freeze head to sandwich the freeze head between the clamp bracket and the pipe; passing the ends of the cord around the pipe and the freeze head; tensioning the cord; and inserting the tensioned ends of the cord into the pair of slots in the clamp bracket.

According to a further aspect of the invention there is provided a capo for a string instrument comprising: a bar carrying a strip to abut strings of said instrument, and an elastic cord threaded through a hole in the bar, the bar being further provided with a slot in an end of the bar distal to the hole, a mouth of the slot being open to an edge of the bar for receiving an end portion of the cord, wherein the width of the slot is such that the cord is insertable into the slot when the cord is tensioned; and the cord is gripped by inner walls of the slot when the cord is untensioned.

According to a further aspect of the invention there is provided a capo for a string instrument comprising: a bar carrying a strip to abut strings of said instrument, and an elastic cord threaded through a hole in the bar, the bar being further provided with a hole for receiving an end portion of the cord, wherein the shape of the hole is such that the cord is insertable into part of the hole when the cord is tensioned; and the cord is gripped by inner walls of an adjoining part of the hole when the cord is untensioned.

The capo has a simple design and can easily be applied to and detached from a stringed instrument such as a guitar.

### BRIEF DESCRIPTION OF THE DRAWINGS

The invention will be further described by way of example with reference to the accompanying drawings in which:

FIG. 1 shows a clamp forming a first embodiment of the invention;

FIG. 2 is a plan view of a clamp bracket of a clamp for use with pipe freezing apparatus forming another embodiment of the invention;

FIG. 3 shows pipe freezing apparatus comprising the clamp bracket shown in FIG. 2;

FIG. 4 is a view of the clamp of FIG. 2 being used with the freeze head of the pipe freezing apparatus of FIG. 3 to freeze the contents of a liquid-filled pipe;

FIG. 5 shows a freeze head forming a further embodiment of the invention;

FIG. 6 shows a clamp forming a further embodiment of the invention;

FIG. 7 shows a clamp forming a further embodiment of the invention;

FIG. 8 shows the clamp of FIG. 7 holding together a pair of skis;

FIG. 9 shows an alternative arrangement of slots in the clamp bracket;

FIG. 10 is a side view of a clamp bracket having a modified slot;

FIG. 11 shows a further modified slot;

FIG. 12 is a perspective view of a tool holder clamp bracket embodying the invention;

FIG. 13 shows a clamp forming a further embodiment of the invention

FIG. 14 shows a capo for a string instrument forming a further embodiment of the invention; and

FIG. 15 shows the capo of FIG. 14 applied to the neck of a guitar.

### DESCRIPTION OF PREFERRED EMBODIMENTS

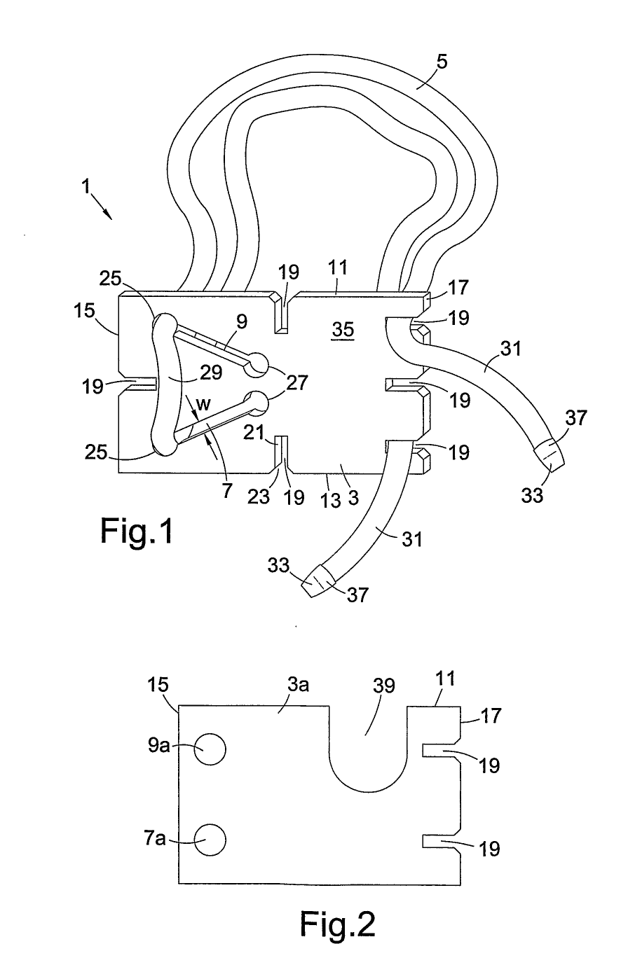

FIG. 1 shows a clamp 1 forming a first embodiment of the invention, the clamp 1 comprising a clamp bracket 3 and an elastic cord 5 threaded through two elongate apertures 7, 9 in the clamp bracket 3. The clamp bracket 3 is made by punching aluminium plate of thickness between 3 mm and 5 mm and preferable of thickness 4 mm. The clamp bracket 3 is a flat plate which is substantially rectangular, having two long sides 11, 13 of length between 80 mm and 100 mm, preferably 90 mm, and two short sides 15, 17 of width between 40 mm and 50 mm, preferably 45 mm.

There are a plurality of open ended slots 19 around the outside edge of the bracket 3; in particular there is one slot 19 in the short side 15 nearest to the apertures 7, 9; three slots 19 distributed along the width of the other short side 17; and one slot 19 in the centre of each of the long sides 11, 13. Each of the slots 19 comprises a root 21 and opens to an edge of the bracket 3 at a mouth 23. Inner edges of the root 21 are substantially parallel and the mouth 23 flares outwardly at the edge of the bracket 3.

The apertures 7, 9 are elongate openings passing through the bracket 3 from one face 35 of the bracket 3 to the other face and are of similar length. The ends 25, 27 of each aperture 7, 9 are substantially round, having a diameter greater than the diameter of the elastic cord 5. The central portion of the each aperture 7, 9 is straight and the width w of the central portion is less than the diameter of the elastic cord 5. The apertures 7, 9 are not parallel to each other but extend at an angle to each other such that a distance between the outer ends 25 of the apertures 7, 9, i.e., the ends of the apertures 7, 9 closest to short side 15 is greater than a distance between the inner ends 27 of the apertures 7, 9.

The cord 5 is a bungee cord which is an elastic cord made of one or more strands of an elastic material, usually rubber, bound together by a fabric covering. When the elastic cord 5 is tensioned the cord 5 increases in length and decreases in diameter. The cord 5 is threaded through the apertures 7, 9 so that a central portion 29 of the cord 5 is looped between the apertures 7, 9 above one face 35 of the clamp bracket 3. While the central portion 29 of the cord 5 is disposed in the apertures 7, 9, end portions 31 of the cord 5 are free to move. The ends 37 of the cord 5 are crimped with crimps 33 to prevent fraying and prevent the cord 5 from being unthreaded from the apertures 7, 9.

The width of the root 21 of the slots 19 in the edges of the clamp bracket 3 is of the order of half the diameter of the cord 5 in an untensioned state, such that when the cord 5 is tensioned, which reduces the diameter of the cord 5, the cord 5 can be inserted into a slot 19. When the cord 5 is disposed in the slot 19 and the tension is released so that the cord 5 is at rest, the diameter of the cord 5 increases to its untensioned, at rest diameter which is greater than the width of the slot 19. Hence the inner walls of the slot 19 grip the cord 5 to hold the cord 5 in place in the root 21 of the slot 19.

A number of slots are positioned around the edge of the clamp bracket 3 to allow the free end portions 31 of the cord 5 to be inserted and held in the slots 19 at a convenient location, depending on what the clamp 1 is being used to hold.

The apertures 7, 9 are elongate so that the central portion 29 of the cord 5 can disposed at a position along the apertures 7, 9 depending on the articles to be attached by the clamp 1. For example, if the articles to be attached together are relatively thin then the central portion 29 of the cord 5 can be located towards the inner ends 27 of the apertures 7, 9; and if the articles to be attached are relatively thick then the central portion 29 of the cord 5 can be located towards the outer ends 25 of the apertures 7, 9. If it is desired to dispose the central portion 29 of the cord 5 at a position between the ends 25, 27 of the aperture then the central portion 29 can be moved to a position along the central portion of the apertures 7, 9 by tensioning the cord 5 to reduce its diameter. Because the width w of the central portion of the apertures 7, 9 is less than the diameter of the elastic cord 5, the central portion 29 of the cord 5 is held in place at a chosen position along the central portion of the apertures 7, 9 by being gripped by the walls of the apertures 7, 9.

In use, when two or more items are to be held together, the clamp bracket 3 is placed against the items to be attached together and the free end portions 31 of the cord 5 are passed around the items, to encircle the items. The cord 5 is tensioned by pulling the end portions 31 of the cord, to hold the items firmly together and to hold the clamp 1 firmly around the items. Whilst tensioning the cord 5 in this manner the diameter of the cord 5 reduces and the reduced diameter end portions 31 of the cord 5 are inserted into slots 19 in one or two edges of the clamp bracket 3. The tension in the cord 5 is released and the untensioned cord 5 increases in diameter so that the clamp bracket 3 grips the cord 5.

By looping the central portion 29 of the cord through the apertures 7, 9 to produce two cord lengths the folded cord 5 applies a force to the items to be attached together along two paths. This applies a firm grip on the items to be attached together and spreads the clamping force over a large length of contact between the cord 5 and the items to be attached, thereby spreading the force over a relatively large contact area. As the clamping force is provided by the two end portions 31 of the cord 5 rather than using a single cord, improved anchorage is provided which inhibits respective twisting of the items being held together, for example, if long narrow items are held by the clamp 1. This can also be achieved by providing two lengths of cord, each cord taking a separate path around the objects to be attached together. In addition, for the embodiment of FIG. 1, the cord 5 is connected to the clamp bracket 3 merely by threading the cord 5 though the apertures 7, 9, which is a quick and simple attachment mechanism and which eliminates the need to attach the cord 5 to the clamp bracket 3 by other means, such as bending the cord back on itself and binding one end of the cord to another part of the cord using thread. Furthermore, if the portion of the cord 5 in the apertures 7, 9 experiences excessive wear then the cord 5 can be slid along so that a different portion of the cord 5 is disposed in the aperture 7, 9 thereby extending the useful life of the cord 5.

FIG. 13 shows a clamp 1d forming another embodiment of the invention. The clamp 1d comprises a clamp bracket 3f and an elastic cord 5 threaded through two circular apertures 7b, 9b in the clamp bracket 3f. The clamp bracket 3f is a flat plate which is substantially rectangular, having two long sides 11, 13 of length between 65 mm and 85 mm, preferably 75 mm, and two short sides 15, 17 of width between 55 mm and 55 mm, preferably 50 mm.

There are two slots 19 in the short side 15 nearest to the apertures 7b, 9b and two slots 19 towards the ends of the other short side 17. Each of the slots 19 has the same shape to the slots 19 of the clamp bracket 3 of FIG. 1.

The cord 5 is made of the same material as the bungee cord 5 of FIG. 1 and is threaded through the apertures 7b, 9b like the bungee cord 5 of FIG. 1. The ends 37 of the cord 5 are crimped with a length of heat shrink 33a to prevent fraying. The crimped ends 37 can pass through the apertures 7b, 9b.

In addition to the slots positioned around the edge of the clamp bracket 3f to allow the free end portions 31 of the cord 5 to be inserted and held in the slots 19 at a convenient location, the clamp bracket 3f is also provided with a pair of keyhole-shaped holes/apertures 19f on the short half of the clamp bracket 3f opposite the apertures 7b, 9b. Each free end 31 of the cord may be anchored in any of the holes 19f or slots 19 to suit the size of the article which the is clamp 1d is being used to hold.

For example, if the articles to be attached together are wider than the length of the clamp bracket 3f then the end portions 31 of the cord 5 are inserted into the holes 19f. If the articles to be attached together are narrower than the width of the clamp bracket 3f then the end portions 31 of the cord 5 are inserted into the slots 19.

The holes 19f for gripping the ends of the cord need not have a precisely keyhole shape, with a circular portion adjoining a narrower rectangular portion. The hole 19f would be similarly capable of gripping the stretched cord with a different elongate shape, with its width varying along its length, provided that the cord could be threaded through part of the hole and then gripped in another part which is adjoining.

FIG. 2 is a plan view of a clamp bracket 3a of a clamp for use with pipe freezing apparatus forming a further embodiment of the invention. Like the clamp bracket 3 of FIG. 1, the clamp bracket 3a of FIG. 2 is a flat plate having slots 19a and a pair of apertures 7a, 9a. The apertures 7a, 9a are substantially round and are disposed towards a short side 15 of the clamp bracket 3a. The diameter of the apertures 7a, 9a is greater than the diameter of an elastic cord 5 used threaded through the clamp bracket 3a, preferably less than 20% greater than the diameter of the cord 5 and further preferably less than 10% greater than the diameter of the cord 5.

There are two slots 19 open to the opposed short side 17 of the clamp bracket 3a. There is also a cut-out 39 in a long side 19 of the clamp bracket 3a to accommodate a refrigerant hose of the pipe freezing apparatus, as explained below.

As for the clamp bracket 3 of FIG. 1, an elastic cord 5 is threaded through the apertures 7a, 9a passing from one face 35 of the bracket 3a to the other face of the bracket 3a. The free end portions of the cord 5 can be inserted and held in the slots 19 as explained below.

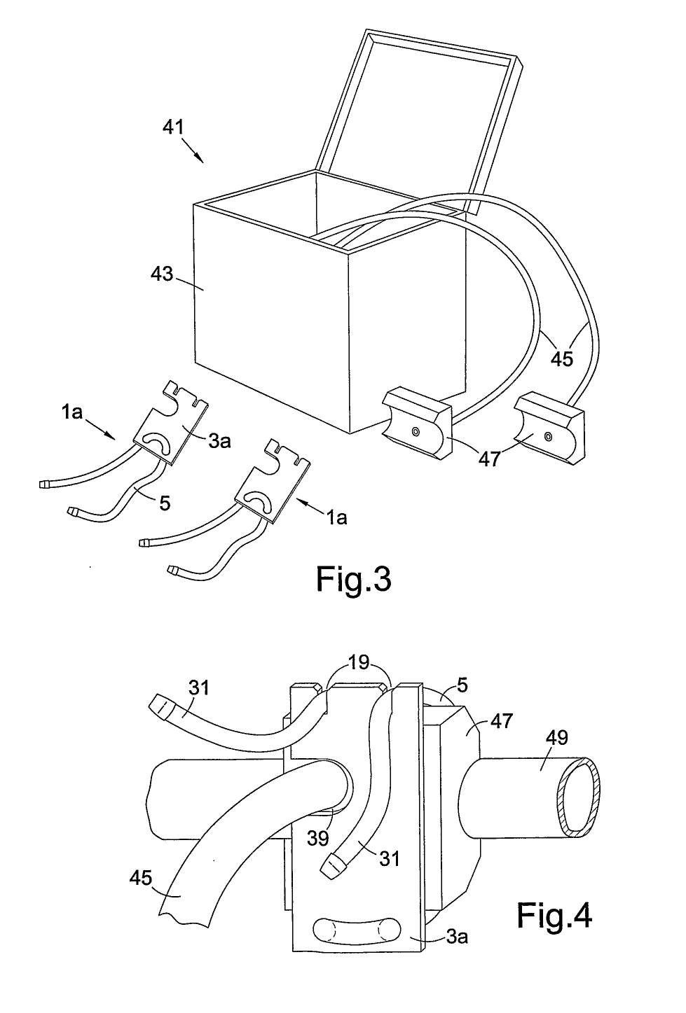

FIG. 3 shows pipe freezing apparatus 41 comprising the clamp bracket 3a shown in FIG. 2. The pipe freezing apparatus 41 comprises a compressor 43 that cools refrigerant and pumps the refrigerant via refrigerant hoses 45 to two freeze heads 47. The active face of the freeze heads 47 is curved to accommodate a pipe, part of the contents of which are to be frozen to create a plug, and head reducers (not shown) are used to reduce the diameter of the curved face to accommodate pipes of a variety of diameters. The pipe freezing apparatus 41 further comprises two clamps 1a, one for each freeze head 47, comprising the clamp bracket 3a of FIG. 2 and an elastic cord 5 for holding the freeze head 47 against a pipe 49, as shown in FIG. 4.

Referring to FIG. 4, in use a freeze head 47 is placed on a liquid-filled pipe 49 and the clamp bracket 3a is placed against a flat face of the freeze head 47 with the refrigerant hose 45 accommodated within the cut-out 39 of the clamp bracket 3a. The free end portions 31 of the cord 5 are passed around the freeze head 47 and the pipe 49 and between the pipe 49 and an adjacent wall (not shown), to encircle the freeze head 47 and the pipe 49. The cord 5 is tensioned by pulling the end portions 31 of the cord, to hold the freeze head 47 firmly on the pipe 49. Whilst tensioning the cord 5 in this manner the diameter of the cord 5 reduces and the reduced diameter end portions 31 of the cord 5 are inserted into slots 19 in the clamp bracket 3a to attach the freeze head 47 to the pipe 49. The tension in the cord 5 is released and the untensioned cord 5 increases in diameter so that the clamp bracket 3a grips the cord 5. A dry cloth (not shown) is wrapped around the freeze head 47 to insulate the freeze head 47 and speed up freezing of the local contents of the pipe 49. This procedure is repeated for the second freeze head 47.

The compressor 43 is turned on and supplies cooled refrigerant to the freeze heads 47 which cools the local contents of the liquid-filled pipe 49 to create a frozen plug in the pipe. Work is undertaken on the system of which the pipe 49 forms a component part and once the work is complete the compressor 43 is turned off, allowing the plug to melt, the free end portions 31 are tensioned so that cord 5 can been removed from the slots 19, the clamp la is removed from the freeze head 47 and the freeze head 47 is removed from the pipe 49.

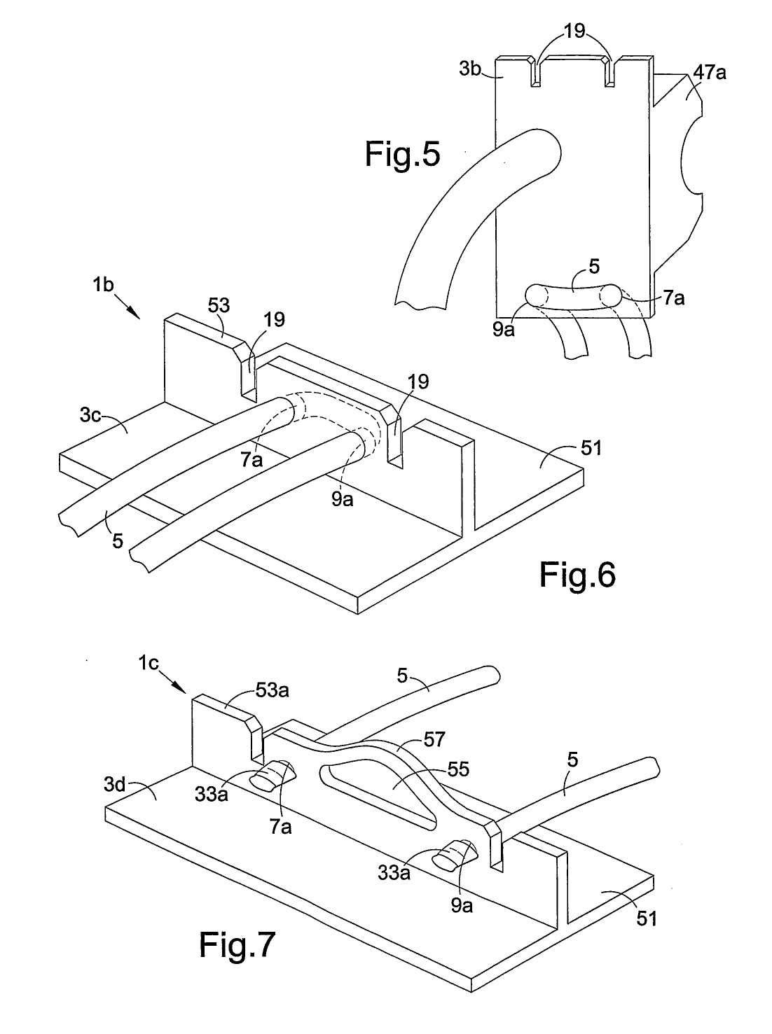

FIG. 5 shows a freeze head 47a forming a further embodiment of the invention. The freeze head 47a is similar to the freeze head 47 of FIGS. 3 and 4 and further includes a clamp bracket 3b similar to the clamp bracket 3a of FIGS. 2 to 4. An elastic cord 5 is threaded through apertures 7a, 9a in the clamp bracket 3b and the free end portions (not shown) of the cord 5 are received in slots 19 in the clamp bracket 3b, as with the clamp bracket 3a of FIGS. 2 to 4. The clamp bracket 3b may be formed as an integral part of the body of the freeze head 47a or may form part of the freeze head 47a by attaching the clamp bracket 3b to the freeze head 47a using adhesive or by other attachment means. For example, the clamp bracket 3b may be attached to the freeze head 47a by drilling a hole in the clamp bracket 3b and fixing a screw through the hole into a tapped hole in the freeze head 47a. An advantage of the freeze head 47a of FIG. 5 is convenient attachment of the freeze head 47a to a liquid-filled pipe 49, as the freeze head 47a with integral clamp bracket 3b can be easily handled and held on the pipe 49 during attachment thereof.

FIG. 6 shows a clamp 1b forming a further embodiment of the invention. The clamp 1b comprises a clamp bracket 3c having a T-shaped cross-section and an elastic cord 5. The clamp bracket 3c has a base plate 51, corresponding to the top of the ‘T’, and a flange 53 extending perpendicularly from a centre of the base plate 51, corresponding to the upright of the ‘T’. Apertures 7a, 9a are formed in the flange 53 through which the elastic cord 5 is threaded. A pair of open-ended slots 19 is formed in an edge of the flange 53 distal to the base plate 51. The shape and size of the slots 19 is similar to those of the slots 19 of previous embodiments.

In use, when two or more items are to be held together, the base plate 51 of the clamp bracket 3c is placed against the items to be attached together and the free end portions of the cord 5 are passed around the items, to encircle the items. The cord 5 is tensioned and the reduced diameter end portions 31 of the cord 5 are inserted into the slots 19 in the flange 53 of the clamp bracket 3c. The tension in the cord 5 is released and the untensioned cord 5 increases in diameter so that the clamp bracket 3c grips the cord 5. The clamp 1b of FIG. 6 is particularly useful when the items to be attached are wider than the width of the base plate 51. Also, the flange 53 can be conveniently gripped to hold the clamp 1b in place when items are attached together with the clamp 1b.

Alternatively, rather than the flange 53 extending perpendicularly from a centre of the base plate 51, the flange 53 may extend perpendicularly from the edge of the base plate 51, such that the clamp bracket is L-shaped rather than T-shaped.

FIG. 7 shows a clamp 1c forming a further embodiment of the invention. The clamp 1c shown in FIG. 7 has a clamp bracket 3d similar to the clamp bracket 3c of the clamp 1b shown in FIG. 6, the clamp bracket 3d having a base plate 51 and flange 53a, except that the clamp bracket 3d is longer than the clamp bracket 3c shown in FIG. 6 and the distance between the apertures 7a, 9a through which the cord is threaded is greater. The increased length of the clamp 1c allows the flange 53a to further comprise an opening 55 forming a handle 57 for convenient gripping of the clamp 1c both when using the clamp 1c to attach items together and also when carrying the items. Due to the extended length of the clamp 1c and in particular due to the distance between the apertures 7a, 9a the clamp 1c comprises two cords 5, one cord threaded through each aperture 7a, 9a. Each end of the cord 5 has a cord stop 33a to prevent the cord from being unthreaded from the apertures 7a, 9a. Alternatively a single cord 5 may be threaded through both apertures 7a, 9a, as in the embodiments described above.

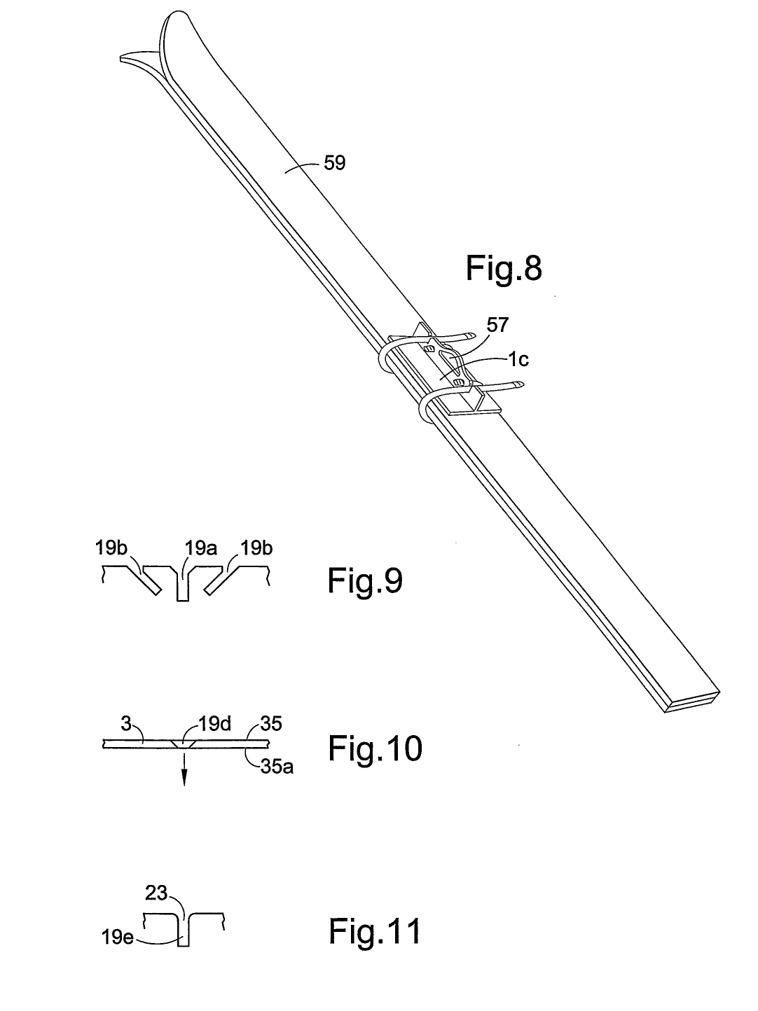

This clamp 1c is particularly useful for attaching together long items such as skis and ski poles, bamboo canes, angling equipment, pipes and poles due to the gap between the lengths of cord 5 passing around the items to be attached which resists twisting of such long items. FIG. 8 shows the clamp 1c of FIG. 7 being used to attach a pair of skis 59 together, wherein the handle 57 can be conveniently used to carry the skis 59.

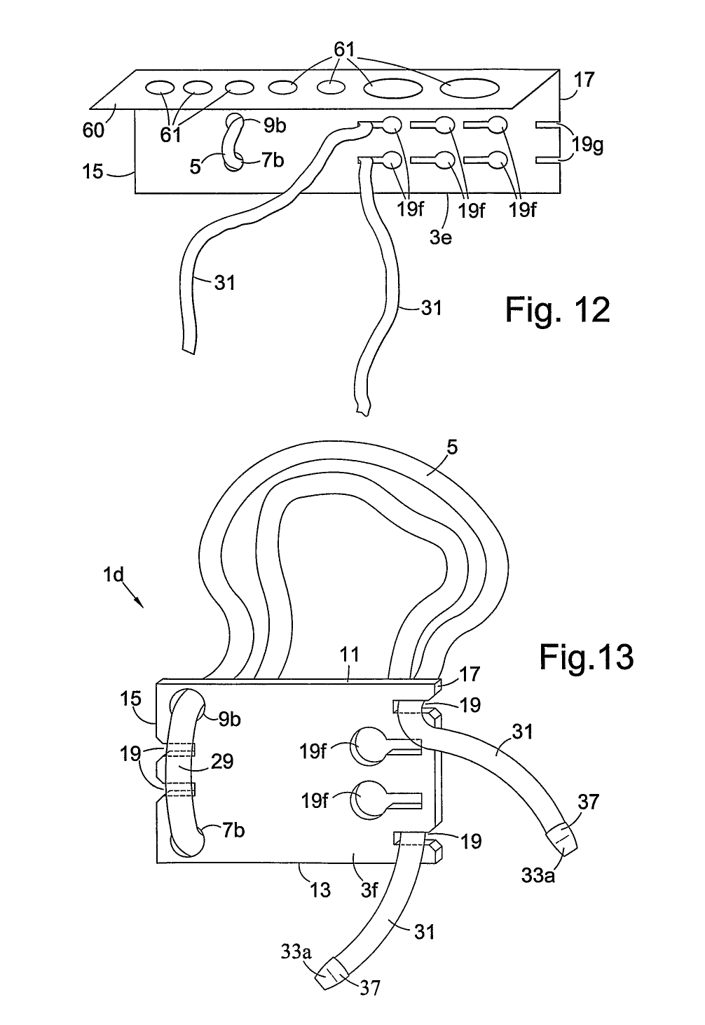

As illustrated in FIG. 12, the clamp bracket 3e may have an extension such as a flange 60 for holding tools such as screwdrivers, cutters and pliers which may have limbs extending through apertures 61 in the planar surface of the flange. The apertures 61 in this example are distributed over the flange in a linear array, and are circular or oval in shape. The flange 60 is at a right angle to the remainder of the clamp bracket so that it is horizontal when the clamp bracket is clamped against a vertical surface such as the side of a ladder. This tool support bracket is more convenient and easier to use than a tool belt, as it can be fitted in the line of vision of a workman on the ladder, closer to the hands holding the ladder, so resulting in less body movement and facilitating better balance.

The tool support bracket 3e has a pair of holes 7b, 9b at one end, for gripping a central loop of the cord 5 as shown in FIG. 12, and three pairs of longitudinally-spaced keyhole-shaped holes 19f at the opposite end, as well as a pair of slots 19g in the short side 17 of the main part of the clamp bracket. The keyhole-shaped holes 19f are similar in shape to the keyhole-shaped holes 19f of the clamp bracket 3f of FIG. 13. Each free end 31 of the cord may be anchored in any of the holes 19f or slots 19g to suit the width of the ladder and the angle of the cord. The tool holding extension 60 could be of any shape and could be applied to any of the embodiments described above.

There is no need for any slots 19g in the edge of the clamp bracket, if there is at least one keyhole-shaped hole such as the keyhole-shaped hole 19f. In one alternative embodiment, there are two such keyhole-shaped holes near one end, and two holes 7b, 9b at the other end.

Further, any of the embodiments shown in FIGS. 1 to 11 could have holes formed in the body of the clamp bracket, similarly to the keyhole-shaped holes 19f of FIG. 12. The cord can be threaded through a wider, circular portion of the hole and then tensioned to anchor itself in the narrower, rectangular portion.

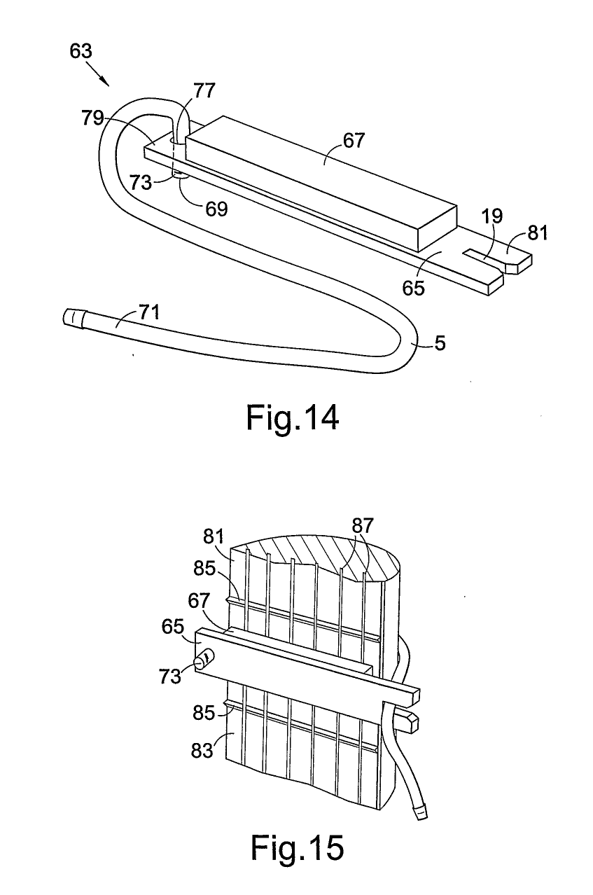

FIG. 14 shows a capo forming an embodiment of the invention. A capo or capotasto is a device used for shortening the vibrating length of strings of a stringed instrument, such as a guitar, mandolin or banjo, in order to raise the pitch of all the strings uniformly.

A capo comprises a bar which is placed over the strings and a clamp to hold the bar against the strings and the fingerboard of the instrument. The bar pushes the strings against a fret, thereby shortening the vibrating length of the strings. The bar is typically a rigid straight or slightly curved bar to which a rubber or plastic strip is applied, the strip in use abutting with the strings. The bar is held on the fingerboard by a clamp taking one of many forms, e.g., a flexible or elastic strap passing around the neck of the instrument, a hinged screw mechanism, a yoke and screw arrangement or a coil spring clamp.

FIG. 14 shows a capo 63 embodying the invention which comprises a bar 65 to which a compressible strip 67 is attached and an elastic cord 5. The ends 69, 71 of the cord 5 are crimped with crimps 73, 75 and one end 69 of the cord 5 is threaded through a hole 77 in one end 79 of the bar 65 and prevented from passing through the hole 77 by the crimp 73.

A slot 19 is provided at the end 81 of the bar 65 distal to the hole 77. The width of the slot 19 and the diameter of the cord 5 are such that when the cord 5 is tensioned, which reduces the diameter of the cord 5, the cord 5 can be inserted into the slot 19. When the cord 5 is disposed in the slot 19 and the tension is released so that the cord 5 is at rest, the diameter of the cord 5 increases to its untensioned, at rest diameter which is greater than the width of the slot 19. Hence the inner walls of the slot 19 grip the cord 5 to hold the cord 5 in place in the slot 19.

FIG. 15 shows the capo 63 applied to a neck 81 of a guitar having a fingerboard 83 with a plurality of frets 85 being traversed by strings 87 running the length of the neck 81. To apply the capo 63 to the neck 81 of the guitar the bar 65 is placed against the strings 87 and the fingerboard 83 between two frets 85, with the strip 67 facing the fingerboard 83. The cord 5 is passed around the rear of the neck 81 and the cord 5 is stretched to reduce its diameter and inserted into the slot 19. The cord 5 is released so that its diameter increases and the sides of the slot 19 grip the cord 5. The capo 63 is removed from the neck 81 of the guitar by tensioning the cord 5 to reduce the diameter of the portion of the cord 5 in the slot 19.

Various modifications will be apparent to those in the art and it is desired to include all such modifications as fall within the scope of the accompanying claims.

For example, the number and position of slots 19 in the clamp bracket 3, 3a-d may be varied. Additional slots may be included in close proximity to each other, for example as shown in FIG. 9, where there are three slots 19a, 19b close to each other. The three slots comprise a centre slot 19a extending perpendicular to the edge of the clamp bracket and a slot 19b on either side of the centre slot 19a and at angle to the centre slot 19a such that the roots of the slots are closer to each other than the openings of the slot in the edge of clamp bracket. This arrangement allows a free end portion of an elastic cord 5 lodged, say, in the centre slot 19a to be fixed also in an adjacent slot 19b to provide a firm anchorage of the cord 5 in the slots 19. The free end portion 31 of the cord could be anchored in any number of the slots 19, so as to lock it more firmly around the clamp bracket, preferably with tension in the portions of cord between those slots. For example, there could be plural slots 19 at each of a pair of opposed sides, such as the short sides 15, 17, of the clamp bracket, allowing the cord to be anchored securely around the clamp bracket.

The slots may be straight or curved, for example, a slot may be curved such that part of a slot may run parallel to the side of the bracket to which that slot opens.

Rather than the width of the root of the slot being constant such that inner walls of the root of the slot are parallel, as shown in FIGS. 1 to 9 and 11, the inner walls of a root of a slot may taper so that the width of the root at the bottom of the root is less than the width of the root nearer to the mouth of the slot.

FIG. 10 is a side view of clamp bracket having a modified slot 19d. The slot 19d is tapered through the thickness of the clamp bracket 3 such that the width of the slot 19d at one face 35 of the clamp bracket 3 is greater than the width of the slot 19d at the opposed face 35a of the clamp plate. This enables a cord 5 in the slot 19d to be tightened by pulling the cord 5 though the tapered slot 19d in a direction of the arrow, from the wide width to the narrow width.

The mouth 23 of a slot 19 may be curved as shown for the slot 19e of FIG. 10, rather than having flat and angled sides as shown in FIGS. 1 to 10, to reduce wear to the cord 5 as it is inserted in the slot 19e.

The shape and size of the apertures 7, 7a, 9, 9a may be varied, such as making the apertures elongated and curved. For example, one aperture may be round or substantially round and the other aperture may be elongate. Only one aperture may be provided in the clamp bracket 3, 3a-d; in this case the cord 5 is threaded through the single aperture and the end portions 31 of the cord are inserted into a pair of slots 19 as described above. This arrangement still benefits from the advantages detailed above associated with applying a force along two paths to the items to be attached. The aperture may be open to an edge of the clamp bracket, the aperture having a similar shape to the slots described above, so that a first portion of the cord is anchored in the aperture/slot, a free end of the elastic cord is passed around the items to be attached together, the cord is stretched and a second portion of the cord inserted into another slot to attach the items together.

Elastic cords other than a bungee cord may be used. Whichever type of elastic cord is used, the width of the root of the slots is chosen such that the cord is insertable into the slot when the cord is tensioned to reduce its diameter; and the cord is gripped by inner walls of the slot when the cord is untensioned.

The ends 37 of the cord 5 may comprise cord stops other than a crimp 33 or length of heat shrink 33a, for example, the cord stop may be tied or sewed to prevent fraying of the cord and/or to prevent the cord from being withdrawn from the apertures 7, 7a, 9, 9a. Alternatively the ends 37 of the cord 5 may be free to be threaded through the apertures.

The shape of the clamp bracket 3, 3a-d may be tailored to a specific application. For example, the clamp bracket may form part of a base to which a notice is attached to form a sign. In this case the openings forming the ‘clamp bracket’ portion of the base are in the middle of a board which extends beyond the ‘clamp bracket’ portion of the base. A notice is attached to or formed on the surface of the board and a bungee cord is threaded through the openings in the middle of the board, around a post, tree or other structure on which the sign is to be hung and fed through the openings in the board to mount the sign on the structure.

The clamp bracket 3, 3a-d may be made of a material other than aluminium, for example metal, plastics or another material. The clamp bracket 3, 3a-d may be made by stamping, extruding or moulding or by another suitable method.

The slot 19 of the capo 63 shown in FIGS. 14 and 15 may be replaced with a keyhole shaped hole as used in the clamps of FIGS. 12 and 13. Instead of the cord 5 being threaded through a hole in the bar 65, the bar may be provided with a slot at each end whereby the cord is tensioned before it is inserted into and held within the slot. The capo 63 may be provided with two cords or with one cord the middle portion of which is threaded through one or two holes in one end of the bar and the other ends are held in one or two slots or holes in the distal end of the bar. Instead of a crimp being applied to the ends of the cord, the ends of the cord can be knotted.

The skilled person will understand that elements of one embodiment can be incorporated in other embodiments.

1. A clamp comprising:
a clamp bracket having a first aperture; and
an elastic cord threaded through the first aperture;
the clamp bracket further comprising:
at least one hole for receiving an end portion of the cord,
wherein the shape of each hole is such that the cord is insertable into part of the hole when the cord is tensioned; and the cord is gripped by inner walls of an adjoining part of the hole when the cord is untensioned.

2. A clamp as claimed in claim 1, in which the holes are substantially keyhole shaped.

3. A clamp as claimed in claim 1, in which there are at least two said holes for receiving respective end portions of the cord.

4. A clamp as claimed in claim 1, the clamp bracket further comprising a second aperture, wherein a central portion of the cord is threaded through the second aperture in addition to the first aperture to form a loop in the central portion of the cord between the first aperture and the second aperture.

5-6. (canceled)

7. A clamp as claimed in claims 1, wherein one or both of the first aperture and second aperture are substantially round.

8. A clamp as claimed in claims 1, wherein one of the first aperture and second aperture is elongated.

9-13. (canceled)

14. A clamp as claimed in claim 1, wherein the width of one or both apertures is greater than the diameter of the cord when the cord is untensioned.

15-16. (canceled)

17. A clamp as claimed in claim 1, comprising one or more slot, a mouth of the or each slot being open to an edge of the clamp bracket for receiving an end portion of the cord, wherein the width of the or each slot is such that the cord is insertable into the slot when the cord is tensioned; and the cord is gripped by inner walls of the slot when the cord is untensioned.

18-19. (canceled)

20. A clamp as claimed in claims 17, wherein the mouth of a slot tapers outwards and inner edges of a root of a slot are parallel to each other.

21-24. (canceled)

25. A clamp as claimed in any one of claims 17, wherein the clamp bracket comprises a base plate and a flange extending from the base plate, one or more of the apertures, slots and holes being disposed in the flange.

26. A clamp as claimed in claim 25, wherein the flange extends from an edge of the base plate such that clamp bracket is L-shaped or the flange extends from a centre of the base plate such that clamp bracket is T-shaped.

27. (canceled)

28. A clamp as claimed in claim 25, further comprising an opening in the flange to provide a handle.

29. A clamp as claimed in claim 1, wherein the cord is a bungee cord.

30. A clamp as claimed in claims 1, wherein the cord further comprises a crimp or length of heat shrink on each end of the cord.

31. A clamp as claimed in claim 30, wherein the crimp or length of heat shrink form a cord stop on one or both ends of the cord to prevent the cord from being withdrawn from the apertures.

32. A clamp as claimed in claims 1, wherein the clamp bracket comprises a cut-out for receiving a hose supplying refrigerant to a freeze head of a pipe freezing machine.

33. A clamp comprising a bracket and an elastic cord, the cord reducing in diameter when stretched, the bracket having a plurality of slots extending in from one or more edge of the bracket, the slots being narrower than the diameter of the unstretched cord.

34. (canceled)

35. A clamp comprising:
a clamp bracket having a first aperture; and
an elastic cord threaded through the first aperture;
the clamp bracket further comprising:
a pair of slots, a mouth of each slot being open to an edge of the clamp bracket for receiving an end portion of the cord,
wherein the width of each slot is such that the cord is insertable into the slot when the cord is tensioned; and the cord is gripped by inner walls of the slot when the cord is untensioned.

36. A clamp as claimed in claim 35, the clamp bracket further comprising a second aperture, wherein a central portion of the cord is threaded through the second aperture in addition to the first aperture to form a loop in the central portion of the cord between the first aperture and the second aperture.

37-66. (canceled)

67. A clamp as claimed in claim 1, the clamp bracket comprising an extension for holding tools, wherein the extension has holes for supporting parts of tools.

68-74. (canceled)

75. Pipe freezing apparatus for freezing liquid in a liquid-filled pipe, the apparatus comprising:
a freeze head to be applied to said pipe;
a compressor for supplying cooled refrigerant to the freeze head; and
a clamp as defined claims 1 for mounting the freeze head on said pipe.

76-79. (canceled)

80. A capo for a string instrument comprising:
a bar carrying a strip to abut strings of said instrument, and
an elastic cord threaded through a hole in the bar,
the bar being further provided with a slot in an end of the bar distal to the hole, a mouth of the slot being open to an edge of the bar for receiving an end portion of the cord,
wherein the width of the slot is such that the cord is insertable into the slot when the cord is tensioned; and the cord is gripped by inner walls of the slot when the cord is untensioned.

81-87. (canceled)
